(19) United States
(12) Patent Application Publication
(10) Pub. No.: US 2026/0149079 A1
(43) Pub. Date: May 28, 2026

(54) SECONDARY BATTERY

(71) Applicant: SK On Co., Ltd., Seoul (KR)

(72) Inventor: Seung Min LEE, Daejeon (KR)

(21) Appl. No.: 19/340,866

(22) Filed: Sep. 26, 2025

(30) Foreign Application Priority Data
Nov. 27, 2024 (KR) 10-2024-0171592

(51) Int. Cl. H01M 10/654; H01M 10/0583; H01M 10/617; H01M 10/647; H01M 10/653; H01M 50/105

(52) U.S. Cl. CPC H01M 10/654; H01M 10/0583; H01M 10/617; H01M 10/647; H01M 10/653; H01M 50/105

(57) ABSTRACT

Disposed herein is a secondary battery. According to the present disclosure, the secondary battery includes an exterior material, an electrode assembly which is accommodated inside the exterior material and in which a first electrode and a second electrode are alternately disposed and repeated with a separator interposed therebetween, and a heat distribution channel provided on one or more of the first and second electrodes and provided to connect a first electrode or second electrode disposed in an inner region of the electrode assembly to a first electrode or second electrode disposed in a relatively outer region.

### CROSS-REFERENCE TO RELATED APPLICATION

This application claims priority to and the benefit of Korean Patent Application No. 10-2024-0171592, filed on Nov. 27, 2024, the disclosure of which is incorporated herein by reference in its entirety.

### BACKGROUND

### 1. Field of the Invention

Embodiments of the present disclosure relate to a secondary battery.

### 2. Discussion of Related Art

Secondary batteries are energy storage devices that can be charged and discharged through electrochemical reactions. Secondary batteries are used in various fields using electric energy. For example, secondary batteries are widely used in mobile devices such as mobile phones, notebooks, and tablets and are also being explored for wider use in transportation such as cars, aircraft, and ships. In addition, the demand for secondary batteries is increasing in the field of energy storage system (ESS) for utilizing surplus power.

For some secondary batteries, such as lithium secondary batteries, a temperature can have a significant effect on performance, lifetime, and safety. Accordingly, such secondary batteries require appropriate thermal management, and, for example, methods of maintaining a secondary battery within an appropriate temperature range through a predetermined temperature control system in each battery pack are known.

### SUMMARY OF THE INVENTION

Some embodiments of the present disclosure may provide a secondary battery.

In addition, some embodiments of the present disclosure may provide a secondary battery with reduced thermal deviation according to an electrode position.

In addition, some embodiments of the present disclosure may provide a secondary battery with improved performance or lifetime.

In addition, some embodiments of the present disclosure may provide a secondary battery with improved stability.

Some embodiments of the present disclosure may be widely applied in green technology fields such as solar power generation and wind power generation using batteries in addition to electric vehicles and battery charging stations. In addition, some embodiments of the present disclosure may be used in eco-friendly electric vehicles, hybrid vehicles, etc., to prevent climate change by suppressing air pollution and greenhouse gas emissions.

According to an aspect of the present disclosure, there is provided a secondary battery including an exterior material, an electrode assembly which is accommodated inside the exterior material and in which a first electrode and a second electrode are alternately disposed and repeated with a separator interposed therebetween, and a heat distribution channel provided on one or more of the first and second electrodes and provided to connect a first electrode or second electrode disposed in an inner region of the electrode assembly to a first electrode or second electrode disposed in a relatively outer region.

In some embodiments, the exterior material may be provided as a flexible film material.

In some embodiments, The electrode assembly may be provided in a rectangular shape with short sides and long sides, and the heat distribution channel may be disposed on the long side and formed to extend along the long side.

In some embodiments, the heat distribution channel may include a first heat distribution channel provided in the first electrode and configured to connect the first electrode disposed in the inner region to the first electrode in the outer region.

In some embodiments, the heat distribution channel may include a second heat distribution channel provided in the second electrode and configured to connect the second electrode disposed in the inner region to the second electrode disposed in the outer region.

In some embodiments, at least a portion of the heat distribution channel may be provided as a thermally conductive material.

In some embodiments, the heat distribution channel may be provided to transfer heat from the inner region to the outer region so that a thermal deviation between the inner region and the outer region is reduced.

In some embodiments, the heat distribution channel may be provided with a plurality of channel bonding portions that are bonded to the first electrode or the second electrode at different positions in an inner-outer direction according to the inner region and the outer region.

In some embodiments, the heat distribution channel may be provided with a channel connector configured to connect the plurality of channel bonding portions to provide a heat transfer path between the plurality of channel bonding portions.

In some embodiments, the plurality of channel bonding portions and the channel connector may be integrally provided.

In some embodiments, the heat distribution channel may be provided in the form of a flexible sheet.

In some embodiments, insulating coating may be performed on an outer surface of the heat distribution channel.

In some embodiments, the heat distribution channel may include one or more of graphene, carbon nanotubes (CNTs), and boron nitride as a material thereof.

In some embodiments, the heat distribution channel may be provided to be bonded to an outer surface of the first electrode or the second electrode by a thermally conductive adhesive.

In some embodiments, the heat distribution channel may be provided with a mesh structure formed of a plurality of wires.

In some embodiments, the electrode assembly may be provided to be wound in a cylindrical shape, and the heat distribution channel may be formed to extend in a radial direction on one surface in a direction of a central shaft of the cylindrical shape to provide a heat transfer path between the inner region and the outer region in the radial direction.

In some embodiments, the heat distribution channel may be provided as a plurality of heat distribution channels disposed on the one surface and spaced apart from each other in a circumferential direction.

In some embodiments, the heat distribution channel may include a first heat distribution channel disposed on a first surface in the direction of the central shaft and configured to connect a first electrode disposed in the inner region to a first electrode disposed in the outer region, and a second heat distribution channel disposed on a second surface that is opposite to the first side and configured to connect the second electrode disposed in the inner region to the second electrode disposed in the outer region.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exterior perspective view illustrating a secondary battery according to one embodiment of the present disclosure;

FIG. 2 is an interior perspective view illustrating an electrode assembly inside the secondary battery of FIG. 1;

FIG. 3 is an exploded perspective view illustrating a heat distribution channel that is separated from that in FIG. 2;

FIG. 4 is a cross-sectional view along line C-C′ shown in FIG. 2;

FIG. 5 is an exploded perspective view illustrating a heat distribution channel according to another embodiment of the present disclosure;

FIG. 6 is a cross-sectional view illustrating a heat distribution channel according to still another embodiment of the present disclosure; and

FIG. 7 is an exploded perspective view illustrating a secondary battery according to another embodiment of the present disclosure.

### DETAILED DESCRIPTION OF EXEMPLARY EMBODIMENTS

Hereinafter, the present disclosure will be described in detail with reference to the accompanying drawings. However, the is merely exemplary and the present disclosure is not limited to specific embodiments described as examples.

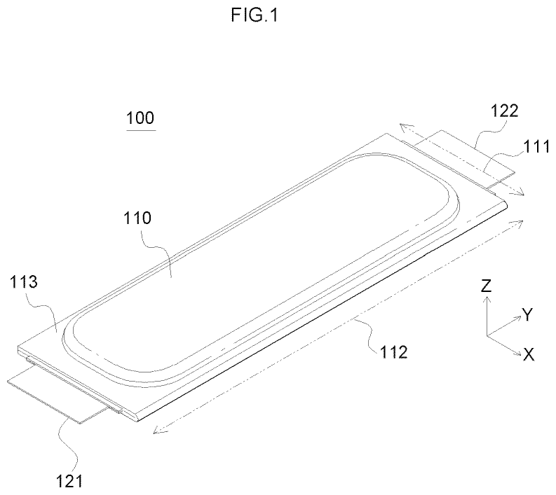

FIG. 1 is an exterior perspective view illustrating a secondary battery according to one embodiment of the present disclosure.

Hereinafter, for convenience, an X-axis direction is referred to as a left-right direction, a Y-axis direction is referred to as a front-rear direction, and a Z-axis direction is referred to as an up-down direction based on coordinate axes shown in FIG. 1 and the like.

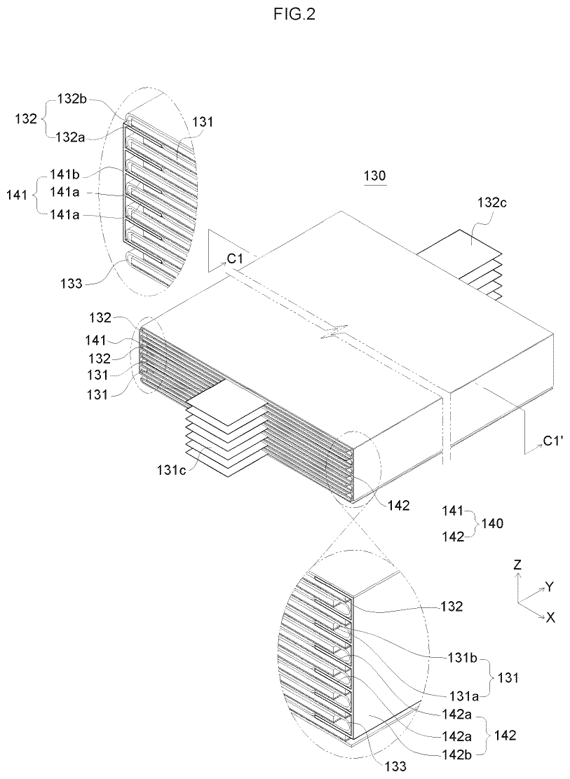

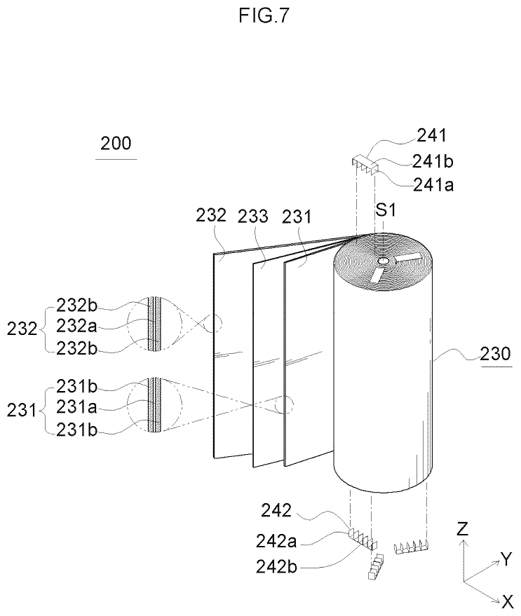

Referring to FIG. 1, in some embodiments, a secondary battery 100 may be provided. In the embodiment shown in the drawing, the secondary battery 100 is exemplified in the form in which an electrode assembly 130 is accommodated in an exterior material 110 made of a flexible film material (see FIG. 2). The secondary battery 100 of this type may be commonly referred to as a pouch-type battery, a pouch-type cell, etc., in the art. However, in the embodiments of the present disclosure, a form factor of the secondary battery 100 is not necessarily limited to that exemplified. Embodiments of the present disclosure may be appropriately implemented or applied to secondary batteries with cylindrical, prismatic, coin-type, or other non-general types, within the scope of the technical ideas which will be described below. For reference, FIG. 7, which will be described below, illustrates an application example for a cylindrical secondary battery.

Meanwhile, in some embodiments, the secondary battery 100 may be provided with the exterior material 110. In the embodiment shown in the drawing, the exterior material 110 is exemplified as a flexible film material. Focusing on the embodiment shown in the drawing, the exterior material 110 may be provided in a substantially rectangular shape on a plane. In addition, the exterior material 110 may be provided with short sides 111 extending in the left-right direction at front and rear ends, respectively, and long sides 112 extending in the front-rear direction at left and right ends, respectively. For convenience, the directions of the short side 111 and the long side 112 according to the exterior material 110 are also used in the electrode assembly 130 which will be described below.

In some embodiments, the exterior material 110 may be formed of a lamination sheet in which a plurality of films, sheets, etc., are bonded together. For example, the exterior material 110 may be provided by bonding polymer resin layers to inner and outer surfaces of a metal sheet made of aluminum, etc. The polymer resin layer provided on the outer surface of the metal sheet may be appropriately selected in consideration of tensile strength, heat resistance, chemical resistance, etc., and may include, for example, nylon, polyethylene terephthalate (PET), or the like as a material. In addition, the polymer resin layer provided on the inner surface of the metal sheet may be appropriately selected in consideration of thermal adhesiveness for sealing, chemical resistance, etc., and may include, for example, a polyolefin resin, a polyurethane resin, a polyimide resin, or the like as a material. The exterior material 110 may be manufactured in a variety of ways. For example, the exterior material 110 may be manufactured by laminating the polymer resin layers on the inner and outer surfaces of the metal sheet and bonding the laminated polymer resin layers using a method such as dry lamination or extrusion lamination.

In some embodiments, the exterior material 110 may be provided by suitably bonding edges of a “pre-processed exterior material” provided as a flexible film material. For example, the exterior material 110 may be provided by folding a single film material in half and bonding edges. Alternatively, the exterior material 110 may be provided by disposing two layers of a film material in contact with each other and bonding edges. In the exterior material 110, a bonding region 113 may be formed along the edge of the exterior material 110, and a space in which the electrode assembly 130 is accommodated may be provided inside the exterior material 110.

Meanwhile, in some embodiments, the secondary battery 100 may be provided with a first electrode lead 121 and a second electrode lead 122. The first electrode lead 121 may be provided as a positive or negative lead, and the second electrode lead 122 corresponding to the first electrode lead 121 may be provided as a negative or positive lead. For convenience, this description assumes that the first electrode lead 121 is a positive lead and the second electrode lead 122 is a negative lead.

In some embodiments, at least portions of the first and second electrode leads 121 and 122 may be disposed to be exposed to the outside of the exterior material 110. In addition, in some embodiments, the first and second electrode leads 121 and 122 may be disposed at the edge of the secondary battery 100. For example, as shown in the drawing, the first electrode lead 121 may be disposed on one short side 111 located at a front end of the secondary battery 100, and the second electrode lead 122 may be disposed on the other short side 111 located at a rear end of the secondary battery 100. However, the arrangement of the first and second electrode leads 121 and 122 may be varied as necessary and is not necessarily limited to the illustrated example. For example, one or more of the first and second electrode leads 121 and 122 may be disposed at the long side 112, or the first and second electrode leads 121 and 122 may be disposed adjacent to each other at one short side 111 or one long side 112.

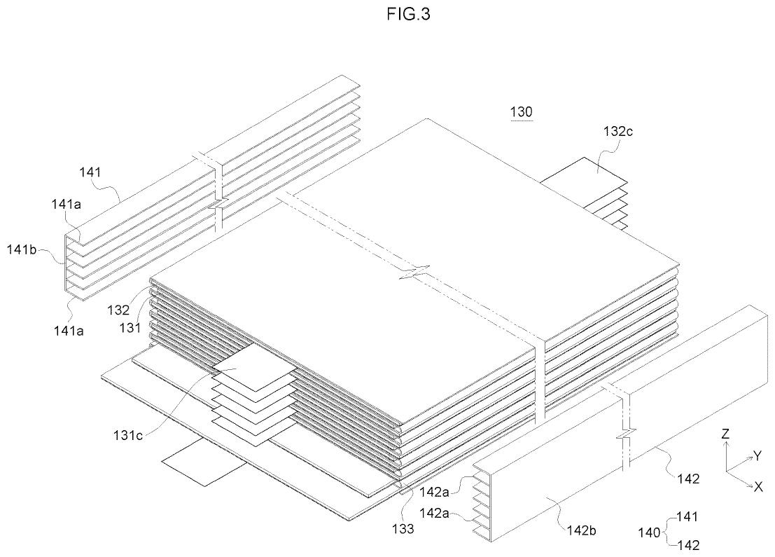

FIG. 2 is an interior perspective view illustrating an electrode assembly inside the secondary battery of FIG. 1. FIG. 3 is an exploded perspective view illustrating a heat distribution channel that is separated from that in FIG. 2.

Referring to FIGS. 2 and 3, in some embodiments, the secondary battery 100 may include the exterior material 110, the electrode assembly 130 accommodated inside the exterior material 110 and provided with a first electrode 131 and a second electrode 132 that are alternately disposed and repeated with a separator 133 interposed therebetween, and a heat distribution channel 140 provided on one or more of the first and second electrodes 131 and 132, wherein the first electrode 131 or the second electrode 132 disposed in an inner region of the electrode assembly 130 is connected to a first electrode 131 or a second electrode 132 that are disposed in the relatively outer region.

Specifically, in some embodiments, the secondary battery 100 may be provided with the exterior material 110. The exterior material 110 may be provided as described above.

Meanwhile, in some embodiments, the secondary battery 100 may be provided with the electrode assembly 130. The electrode assembly 130 may be accommodated inside the exterior material 110 together with an electrolyte, etc. In some embodiments, the electrode assembly 130 may include the first electrode 131 and the second electrode 132 that are disposed with the separator 133 interposed therebetween. The first electrode 131 may be provided as a positive or negative electrode, and the second electrode 132 corresponding to the first electrode 131 may be provided as a negative or positive electrode. For convenience, this description assumes that the first electrode 131 is a positive electrode corresponding to the first electrode lead 121, and the second electrode 132 is a negative electrode corresponding to the second electrode lead 122.

In some embodiments, the first electrode 131 may include a positive electrode current collector 131a and a positive electrode composite layer 131b. For example, the positive electrode current collector 131a may include aluminum, stainless steel, nickel, titanium, or an alloy thereof. The positive electrode composite layer 131b may be provided on at least one surface of the positive electrode current collector 131a. The positive electrode composite layer 131b may include a positive electrode active material, and the positive electrode active material may include a compound capable of reversibly intercalating and deintercalating lithium ions. For example, the positive electrode active material may include a lithium-nickel metal oxide, and in some cases, the lithium-nickel metal oxide may further include cobalt, manganese, aluminum, etc.

In some embodiments, the second electrode 132 may include a negative electrode current collector 132a and a negative electrode composite layer 132b. For example, the negative electrode current collector 132a may include copper, stainless steel, nickel, titanium, or an alloy thereof. The negative electrode composite layer 132b may be provided on at least one surface of the negative electrode current collector 132a. The negative electrode composite layer 132b may include a negative electrode active material, and the negative electrode active material may include a compound capable of reversibly intercalating and deintercalating lithium ions. For example, the negative electrode active material may include a carbon-based material such as crystalline carbon, amorphous carbon, carbon composites, or carbon fibers. Alternatively, the negative electrode active material may include lithium metal, a lithium alloy, a silicon-containing material, a tin-containing material, or the like.

The separator 133 may be provided between the first and second electrodes 131 and 132. The separator 133 may be provided to limit an electrical short circuit between the first and second electrodes 131 and 132 and to generate a flow of ions. In some embodiments, the separator 133 may include a porous polymer film, a porous nonwoven fabric, or the like. For example, the porous polymer film may include a polyolefin-based polymer such as an ethylene polymer, a propylene polymer, an ethylene/butene copolymer, an ethylene/hexene copolymer, an ethylene/methacrylate copolymer, or the like. In addition, the porous nonwoven fabric may include high-melting point glass fibers, PET fibers, etc.

In some embodiments, in the electrode assembly 130, the first and second electrodes 131 and 132 may be provided to be disposed in a repetitive manner with the separator 133 interposed therebetween. That is, the electrode assembly 130 in which the first electrode 131, the separator 133, the second electrode 132, the separator 133, and the first electrode 131 are repeatedly disposed in the order may be provided. The number of the first and second electrodes 131 and 132 and separator 133 may increase or decrease as necessary and is not particularly limited to the shown numbers.

In some embodiments, the electrode assembly 130 may be provided in a winding type, a stacking type, a zigzag-folding (z-folding) type, a stack-folding type, or the like. The winding type may be provided by winding the first and second electrodes 131 and 132 and the separator 133 in a cylindrical type or by pressing the winding cylindrical shape flat, and the stacking type may be provided by stacking the first and second electrodes 131 and 132 and the separator 133, each provided in the form of a sheet. In addition, the z-folding type may be provided in a structure in which a continuous sheet-type separator 133 is folded in a zigzag shape and the first and second electrodes 131 and 132 are alternately inserted at each folding position, and the stack-folding type may be provided in a structure in which a continuous sheet-type separator 133 in which the first and second electrodes 131 and 132 are stacked in a predetermined unit is wound. For reference, the embodiment shown in the drawing illustrates a z-folding type electrode assembly 130. However, the stacking structure of the electrode assembly 130 may be modified in various ways as necessary and is not necessarily limited to the illustrated example. For example, FIG. 7, which will be described below, illustrates an application example for an electrode assembly provided in the winding type.

Meanwhile, in some embodiments, the electrode assembly 130 may be provided in a rectangular shape with short sides and long sides. The short side and the long side of the electrode assembly 130 correspond to the directions of the short side 111 and the long side 112 of the exterior material 110 described above. That is, in the embodiment shown in the drawing, the electrode assembly 130 may be provided with short sides extending in the left-right direction at the front and rear ends, respectively, and may be provided with long sides extending in the front-rear direction at the left and right ends, respectively. In addition, the electrode assembly 130 may be provided in a rectangular shape including the short sides and the long sides on a plane.

In some embodiments, the electrode assembly 130 may include a first electrode tab 131c and a second electrode tab 132c. The first electrode tab 131c may be provided by extending from the first electrode 131, and the second electrode tab 132c may be provided by extending from the second electrode 132. More specifically, in the embodiment shown in the drawing, the first electrode tab 131c may be provided as a portion which extends from the positive electrode current collector 131a and in which the positive electrode composite layer 131b is omitted, and the second electrode tab 132c may be provided as a portion which extends from the negative electrode current collector 132a and in which the negative electrode composite layer 132b is omitted.

In some embodiments, the first and second electrode tabs 131c and 132c may be disposed on the short sides of the electrode assembly 130. That is, the first electrode tab 131c may be disposed on one short side located at the front end of the electrode assembly 130, and the second electrode tab 132c may be disposed on the other short side located at the rear end of the electrode assembly 130. The arrangement of the first and second electrode tabs 131c and 132c relates to the arrangement of the heat distribution channel 140 which will be described below. That is, in some embodiments, the heat distribution channel 140 may be disposed in an edge where the first and second electrode tabs 131c and 132c are not disposed. The arrangement of the heat distribution channel 140 may contribute to preventing interference with the first and second electrode tabs 131c and 132c and securing a wide area for a heat transfer path which will be described below.

In some embodiments, the heat distribution channel 140 may be disposed on the long side of the electrode assembly 130. In addition, the heat distribution channel 140 may be formed to extend along the long side of the electrode assembly 130. In some embodiments, the heat distribution channel 140 may be formed to extend from the front end to the rear end of the electrode assembly 130 along the long side of the electrode assembly 130. In this way, the heat distribution channel 140 may contribute to securing a wide area for the heat transfer path which will be described below.

Meanwhile, in some embodiments, the secondary battery 100 may be provided with the heat distribution channel 140. The heat distribution channel 140 may be provided to connect the first electrode 131 disposed in the inner region of the electrode assembly 130 to the first electrode 131 disposed in the relatively outer region. Alternatively, the heat distribution channel 140 may be provided to connect the second electrode 132 disposed in the inner region of the electrode assembly 130 to the second electrode 132 disposed in the relatively outer region. The heat distribution channel 140 may provide a heat transfer path between the first electrode 131 or the second electrode 132 disposed in the inner region and the first electrode 131 or the second electrode 132 disposed in the outer region. In addition, the heat distribution channel 140 may function to transfer or distribute heat between the first electrode 131 or the second electrode 132 disposed in the inner region and the first electrode 131 or the second electrode 132 disposed in the outer region.

Specifically, in some embodiments, the heat distribution channel 140 may include a first heat distribution channel 141. One portion of the first heat distribution channel 141 may be connected to the first electrode 131 disposed in the inner region. In addition, the other portion of the first heat distribution channel 141 may be connected to the first electrode 131 disposed in the outer region. That is, the first heat distribution channel 141 may be provided to connect the first electrode 131 disposed in the inner region and the first electrode 131 disposed in the outer region to each other.

In the above description, the “inner region” may be a region disposed close to an inside of the electrode assembly 130 and relatively far from an outer surface of the electrode assembly 130. In addition, the “outer region” may be a region disposed relatively close to the outer surface of the electrode assembly 130. That is, focusing on the embodiment shown in the drawing, the electrode assembly 130 in which the first and second electrodes 131 and 132 are stacked vertically to have a predetermined thickness may be provided, and the inner region may be a region relatively adjacent to the center in a thickness direction. In addition, the outer region may be an edge region in a relatively thickness direction, i.e., a region adjacent to an upper surface or a bottom surface of the electrode assembly 130. According to this description, the first heat distribution channel 141 may be provided to connect the first electrode 131 disposed adjacent to the center in the thickness direction of the electrode assembly 130 to the first electrode 131 disposed adjacent to the upper or bottom surface of the electrode assembly 130.

In addition, in some embodiments, the heat distribution channel 140 may include a second heat distribution channel 142. Similar to the first heat distribution channel 141 described above, the second heat distribution channel 142 may be provided to connect the second electrode 132 disposed in the inner region and the second electrode 132 disposed in the outer region to each other.

In some embodiments, the heat distribution channel 140 may be partially or entirely made of a thermally conductive material. For example, the heat distribution channel 140 may be provided by forming a thermally conductive material into a predetermined shape as shown in the drawing or the thermally conductive material may be disposed inside or outside the heat distribution channel 140. Accordingly, the heat distribution channel 140 may function to transfer or distribute heat between the inner and outer regions.

In some embodiments, the heat distribution channel 140 may include one or more of graphene, carbon nanotubes (CNTs), and boron nitride as a material thereof. More specifically, the heat distribution channel 140 may partially or entirely include boron nitride as a material thereof. The heat distribution channel 140 made of the above material may contribute to further improving a heat transfer or distribution function between the inner and outer regions in terms of good thermal conductivity, stability in the electrolyte, and weight reduction.

In some embodiments, the heat distribution channel 140 may be provided in the form of a flexible sheet. For example, the heat distribution channel 140 may be provided by processing a flexible sheet material with thermal conductivity in a predetermined shape. The heat distribution channel 140 in the form of a flexible sheet may contribute to facilitating bonding with the electrode assembly 130 and properly maintaining a bonding state of the heat distribution channel 140 in response to mechanical deformation of the electrode assembly 130.

In some embodiments, insulating coating may be performed on an outer surface of the heat distribution channel 140. Insulating coating is for limiting an electrical short circuit between the heat distribution channel 140 and the first electrode 131 or second electrode 132.

In some embodiments, the heat distribution channel 140 may be provided to be bonded to an outer surface of the first electrode 131 or the second electrode 132 by a thermally conductive adhesive. The thermally conductive adhesive enables the heat distribution channel 140 to maintain proper bonding with the first electrode 131 or the second electrode 132. In addition, the thermally conductive adhesive can contribute to improving the heat transfer or distribution function through the heat distribution channel 140 by reducing heat loss on a bonding surface of the heat distribution channel 140 and the first electrode 131 or second electrode 132.

Meanwhile, in some embodiments, the heat distribution channel 140 may be provided with channel bonding portions 141a and 142a and channel connectors 141b and 142b. For convenience, in this description, the channel bonding portion 141a and the channel connector 141b corresponding to the first heat distribution channel 141 are referred to as a first channel bonding portion 141a and a first channel connector 141b, respectively, and the channel bonding portion 142a and the channel connector 142b corresponding to the second heat distribution channel 142 are referred to as a second channel bonding portion 142a and a second channel connector 142b, respectively.

Focusing on the first heat distribution channel 141, the first channel bonding portion 141a may be provided as a plurality of first channel bonding portions 141a. The plurality of first channel bonding portions 141a may be disposed at different positions in inner and outer directions of the electrode assembly 130. In addition, the plurality of first channel bonding portions 141a may be bonded to the first electrode 131 at different positions. That is, in the embodiment shown in the drawing, the plurality of first channel bonding portions 141a may be disposed at different positions in the thickness direction of the electrode assembly 130 and bonded to the corresponding first electrode 131 at each position in the thickness direction. Accordingly, the plurality of first channel bonding portions 141a may be bonded to the first electrodes 131 disposed in the inner and outer regions of the electrode assembly 130.

The plurality of first channel bonding portions 141a may be connected to each other through the first channel connector 141b. In other words, each first channel bonding portion 141a may be formed to extend from one first channel connector 141b. Accordingly, heat transmitted through each first channel bonding portion 141a may be transmitted to another first channel bonding portion 141a through the first channel connector 141b. That is, the first channel connector 141b may function to provide a heat transfer path between the plurality of first channel bonding portions 141a.

In some embodiments, the plurality of first channel bonding portions 141a and the first channel connector 141b may be integrally provided. For example, the plurality of first channel bonding portions 141a and the first channel connector 141b may be provided by processing one sheet material in a predetermined shape or molding one thermally conductive material in a predetermined shape. In this way, the integrated heat distribution channel 140 may contribute to improving assemblability with the electrode assembly 130.

Similar to the first heat distribution channel 141, the second heat distribution channel 142 may be provided with a plurality of second channel bonding portions 142a and a second channel connectors 142b, and the plurality of second channel bonding portions 142a may be connected through the second channel connector 142b. In addition, the second channel connector 142b may function to provide a heat transfer path between the plurality of second channel bonding portions 142a.

In some embodiments, the first heat distribution channel 141 and the second heat distribution channel 142 may be disposed at separated positions along the edge of the electrode assembly 130. For example, as shown in the drawing, the first heat distribution channel 141 may be disposed on a long side of one side of the electrode assembly 130, and the second heat distribution channel 142 may be disposed on a long side that is opposite to the long side of one side. The arrangement of the first and second heat distribution channels 141 and 142 may contribute to reducing a thermal deviation in a plane direction through indirect heat transfer and the like.

However, the arrangement of the first and second heat distribution channels 141 and 142 is not necessarily limited to the above-illustrated example. The first and second heat distribution channels 141 and 142 may be disposed at various positions other than those illustrated, as long as they can function to reduce a thermal deviation between the inner and outer regions. For example, one or more of the first and second heat distribution channels 141 and 142 may be disposed on the short side of the electrode assembly 130. Alternatively, the first and second heat distribution channels 141 and 142 may be disposed in the inner region of the electrode assembly 130 on a plane or disposed at any position where heat transfer between the inner and outer regions is possible.

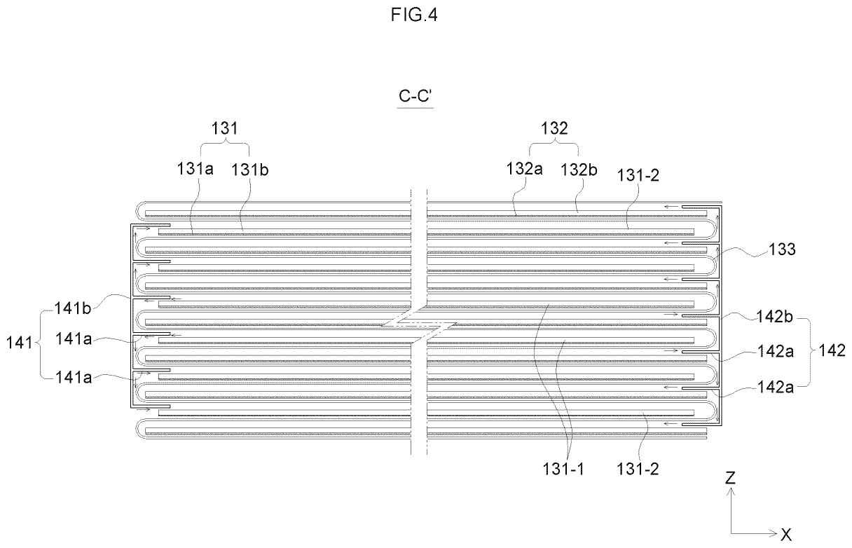

FIG. 4 is a cross-sectional view along line C-C′ shown in FIG. 2.

For reference, for convenience of illustration in FIG. 4, the first electrode 131, the separator 133, and the second electrode 132 are shown slightly apart from each other vertically. The electrode assembly 130 may be provided by closely stacking the first electrode 131, the separator 133, and the second electrode 132, which are shown in the drawing.

Referring to FIG. 4, in some embodiments, the heat distribution channel 140 may be provided to transfer heat from the inner region to the outer region of the electrode assembly 130. Thus, the heat distribution channel 140 may be provided to reduce a thermal deviation between the inner and outer regions. For example, the heat distribution channel 140 may be provided to increase thermal conductivity of the secondary battery 100 in the thickness direction along the inner and outer regions to 3 W/mK or more, or 5 W/mK or more, and thus the thermal deviation between the inner and outer regions can be reduced.

Specifically, focusing on the first heat distribution channel 141, in some use environments, a first electrode 131-1 disposed in the inner region may have a different temperature distribution from a first electrode 131-2 disposed in the outer region. For example, while normal charging or discharging, the first electrode 131-1 in the inner region may have a higher temperature distribution than the first electrode 131-2 in the outer region. For example, a first electrode 131-1 disposed in a central portion may have a temperature that is 10 to 20% higher than that of a first electrode 131-2 disposed in the outermost portion. Although the same heat is generated from each of the first electrodes 131-1 and 131-2, the first electrode 131-1 disposed in the inner region may have relatively difficulty in dissipating heat to the outside, resulting in heat accumulation inside. The thermal deviation may cause a difference in electrochemical behavior such as internal resistance between stacks (first electrodes 131), which can lead to a performance deviation, local degradation, etc.

In addition, the thermal deviation may appear conversely in a low temperature environment. That is, in a low temperature environment, heat is applied to the outer surface of the secondary battery 100 through a temperature control system provided in the battery pack. In this case, the stacks disposed in the relatively outer region may be heated first, and the stacks disposed in the inner region may be heated later. Accordingly, resistance of the stack disposed in the inner region increases relatively, and lithium plating or dendrite formation may occur while rapid charging.

The first heat distribution channel 141 may effectively contribute to reducing the thermal deviation between the inner and outer regions by providing a heat transfer path between the inner and outer regions. In addition, the second heat distribution channel 142 functions similarly to the first heat distribution channel 141 and may effectively contribute to reducing the thermal deviation between the inner and outer regions of the second electrode 132.

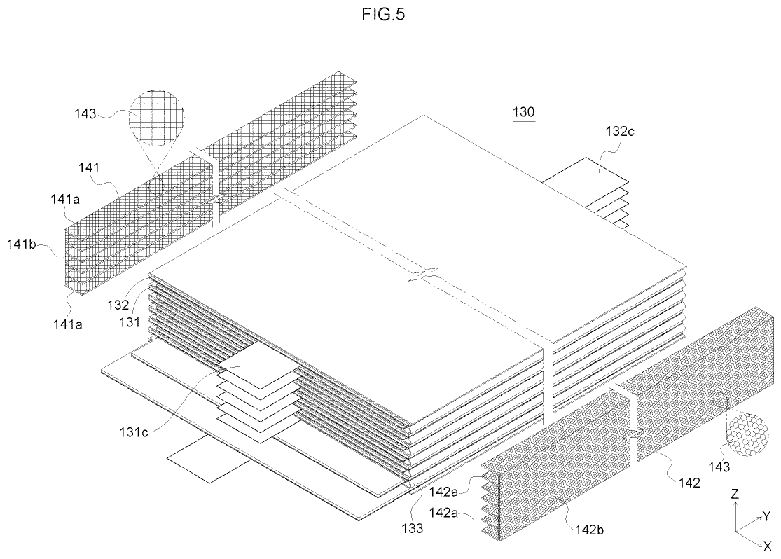

FIG. 5 is an exploded perspective view illustrating a heat distribution channel according to another embodiment of the present disclosure.

For convenience, hereinafter, a difference from the above embodiment will be described mainly.

Referring to FIG. 5, in some embodiments, a heat distribution channel 140 may be provided with a mesh structure formed of a plurality of wires 143. That is, the heat distribution channel 140 of the above-described embodiment is provided in the form of a sheet with a constant surface area, whereas the heat distribution channel 140 of the embodiment shown in the drawing may be provided with a mesh structure formed of the plurality of wires 143. The heat distribution channel 140 may have the advantage of not hindering a flow of an electrolyte while maintaining the function of the above-described reducing thermal deviation.

The above mesh structure may be implemented in various forms. For example, the mesh structure may be provided in the form in which the wire 143 forms a polygonal shape such as a quadrangular shape, a rhombic shape, or a hexagonal shape and extends. Alternatively, the mesh structure may be provided in the form in which the wire 143 forms a regular or irregular pattern and extends. For reference, in the embodiment shown in the drawing, an example in which the first heat distribution channel 141 is provided with a mesh structure in the form of a substantially quadrangular or grid shape, and the second heat distribution channel 142 is provided with a mesh structure in the form of a substantially hexagonal shape is exemplified.

Although not shown in the drawing, in some embodiments, the heat distribution channel 140 may be provided with a plurality of holes for a flow of an electrolyte. That is, the heat distribution channel 140 may be provided in the form of a sheet having a constant surface area and may be provided with the plurality of holes formed on an outer surface of the sheet. The heat distribution channel 140 may function without hindering the flow of the electrolyte while securing an appropriate cross-sectional area for heat transfer.

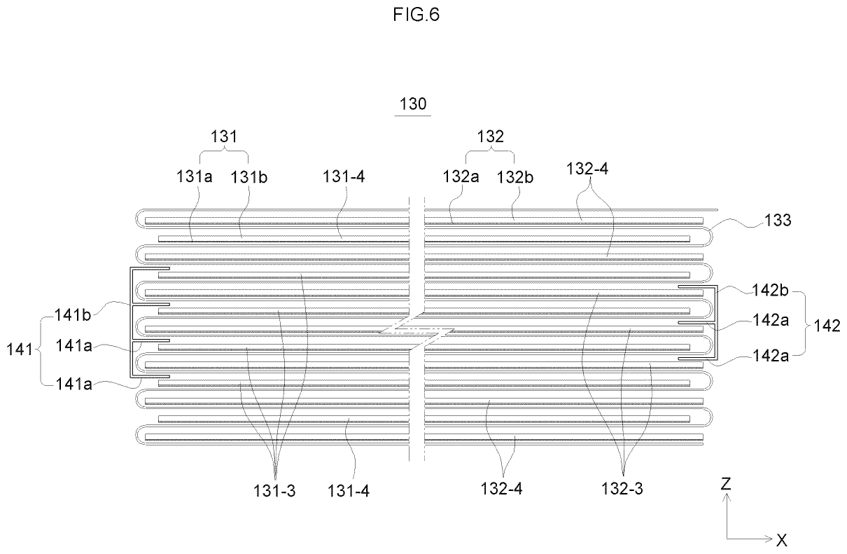

FIG. 6 is cross-sectional view illustrating a heat distribution channel according to still another embodiment of the present disclosure.

Referring to FIG. 6, in some embodiments, a heat distribution channel 140 may be limitedly provided only in an area adjacent to the center of the electrode assembly 130 of the thickness direction. For example, as shown in the drawing, a first heat distribution channel 141 may be provided only between some of first electrodes 131-3 disposed in a central region among a plurality of first electrodes 131 and may be appropriately omitted from the remaining first electrodes 131-4 disposed in an outer region of the central region. Similarly, a second heat distribution channel 142 may be limitedly provided only between some of second electrodes 132-3 disposed in the central region. This is a result in consideration that the first electrode 131-4 or the second electrode 132-4 disposed in the outer region has relatively low thermal deviation.

FIG. 7 is an exploded perspective view illustrating a secondary battery according to another embodiment of the present disclosure.

FIG. 7 illustrates a case in which a heat distribution channel 240 is applied to a cylindrical secondary battery 200.

Referring to FIG. 7, in some embodiments, the secondary battery 200 may be provided as a cylindrical battery. In addition, an electrode assembly 230 may be provided with first and second electrodes 231 and 232 wound in a cylindrical shape with a separator 233 interposed therebetween. Here, a heat distribution channel 240 may be provided to provide a heat transfer path between an inner region and an outer region in a radial direction for the cylindrical electrode assembly 230.

That is, to describe a first heat distribution channel 241 disposed on an upper surface of the electrode assembly 230 mainly, the first heat distribution channel 241 may be formed to extend radially from a central shaft S1 of the electrode assembly 230 and may be provided to connect a first electrode 231-1 disposed in the inner region in the radial direction to a first electrode 231-2 disposed in outer region in the radial direction. Accordingly, the first heat distribution channel 241 may be formed to provide a heat transfer path between the first electrode 231-1 disposed in the inner region and the first electrode 231-2 disposed in the outer region.

For reference, in the winding-type electrode assembly 230, the first electrode 231-1 disposed in the inner region in the radial direction and the first electrode 231-2 disposed in the outer region in the radial direction may be substantially provided as one first electrode 231. That is, the first electrode 231 may be provided in the form of a single sheet extending long in a winding direction. As the first electrode 231 is wound around the central shaft S1, the first electrode 231-1 in the inner region and the first electrode 231-2 in the outer region may be provided. In other words, in the present embodiment, the first electrode 231-1 in the inner region may be provided as a portion of the first electrode 231 relatively adjacent to the central shaft S1, and the first electrode 231-2 in the outer region may be provided as another portion of the first electrode 231 relatively spaced apart from the central shaft S1.

Meanwhile, in some embodiments, the heat distribution channel 240 may have a predetermined width along the central shaft S1 in a circumferential direction. The width of the heat distribution channel 240 may function to appropriately secure a cross-sectional area for heat transfer between the inner and outer regions.

In some embodiments, the heat distribution channel 240 may be provided as a plurality of heat distribution channels 240 on one surface of the electrode assembly 230. In addition, the plurality of heat distribution channels 240 may be spaced apart along the central shaft S1 in the circumferential direction. For example, as shown in the drawing, three first heat distribution channels 241 may be provided on an upper surface of the electrode assembly 230, and the three first heat distribution channels 241 may be spaced apart at equal intervals in the circumferential direction. However, the number of the heat distribution channels 240 and positions thereof may be varied as necessary and are not necessarily limited to the above-described example.

In some embodiments, the heat distribution channel 240 may include first and second heat distribution channels 241 and 242. The first heat distribution channel 241 may be provided to perform heat transfer between the inner and outer regions for the first electrode 231, and the second heat distribution channel 242 may be provided to perform heat transfer between the inner and outer regions for the second electrode 232. In some embodiments, the first and second heat distribution channels 241 and 242 may be disposed on upper and lower surfaces of the electrode assembly 230, respectively. That is, the first heat distribution channel 241 may be disposed on a first surface (the upper surface) in a direction of the central shaft S1 and provided to perform heat transfer between the inner and outer regions for the first electrode 231, and the second heat distribution channel 242 may be disposed on a second surface (the lower surface) on a corresponding opposite side and provided to perform heat transfer between the inner and outer regions for the second electrode 232.

As described above, the embodiments of the present disclosure can provide a secondary battery.

In addition, some embodiments of the present disclosure can contribute to reducing a thermal deviation according to an electrode position. In some embodiments, a heat distribution channel can be provided to connect an electrode disposed in an inner region of an electrode assembly and an electrode disposed in an outer region, thereby contributing to reducing a thermal deviation between the inner and outer regions.

In addition, some embodiments of the present disclosure can contribute to improving performance and lifetime of the secondary battery. In some embodiments, the heat distribution channel can function to generate a uniform temperature distribution across the entire region of the electrode assembly, which can help prevent performance variation and localized degradation according to an electrode position.

In addition, some embodiments of the present disclosure can contribute to improving stability of the secondary battery. In some embodiments, the heat distribution channel can function to appropriately limit lithium plating or dendrite formation, which can contribute to preventing an electrode failure and an electrical short circuit due to dendrite growth.

Some embodiments of the present disclosure can provide a secondary battery.

In addition, some embodiments of the present disclosure can provide a secondary battery with reduced thermal deviation can be reduced according to an electrode position.

In addition, some embodiments of the present disclosure can provide a secondary battery with improved performance or lifetime.

In addition, some embodiments of the present disclosure can provide a secondary battery with improved stability.

The content described above is merely an example of applying the principle of the present disclosure, and other configurations may be further included without departing from the scope of the present disclosure.

What is claimed is:

1. A secondary battery comprising:
an exterior material;
an electrode assembly which is accommodated inside the exterior material and in which a first electrode and a second electrode are alternately disposed and repeated with a separator interposed therebetween; and
a heat distribution channel provided on one or more of the first and second electrodes and provided to connect a first electrode or second electrode disposed in an inner region of the electrode assembly to a first electrode or second electrode disposed in a relatively outer region.

2. The secondary battery of claim 1, wherein the exterior material is provided as a flexible film material.

3. The secondary battery of claim 1, wherein:
the electrode assembly is provided in a rectangular shape with short sides and long sides; and
the heat distribution channel is disposed on the long side and formed to extend along the long side.

4. The secondary battery of claim 1, wherein the heat distribution channel includes a first heat distribution channel provided in the first electrode and configured to connect the first electrode disposed in the inner region to the first electrode in the outer region.

5. The secondary battery of claim 4, wherein the heat distribution channel includes a second heat distribution channel provided in the second electrode and configured to connect the second electrode disposed in the inner region to the second electrode disposed in the outer region.

6. The secondary battery of claim 1, wherein at least a portion of the heat distribution channel is provided as a thermally conductive material.

7. The secondary battery of claim 1, wherein the heat distribution channel is provided to transfer heat from the inner region to the outer region so that a thermal deviation between the inner region and the outer region is reduced.

8. The secondary battery of claim 1, wherein the heat distribution channel is provided with a plurality of channel bonding portions that are bonded to the first electrode or the second electrode at different positions in an inner-outer direction according to the inner region and the outer region.

9. The secondary battery of claim 8, wherein the heat distribution channel is provided with a channel connector configured to connect the plurality of channel bonding portions to provide a heat transfer path between the plurality of channel bonding portions.

10. The secondary battery of claim 9, wherein the plurality of channel bonding portions and the channel connector are integrally provided.

11. The secondary battery of claim 1, wherein the heat distribution channel is provided in a form of a flexible sheet.

12. The secondary battery of claim 1, wherein insulating coating is performed on an outer surface of the heat distribution channel.

13. The secondary battery of claim 1, wherein the heat distribution channel includes one or more of graphene, carbon nanotubes (CNTs), and boron nitride as a material thereof.

14. The secondary battery of claim 1, wherein the heat distribution channel is provided to be bonded to an outer surface of the first electrode or the second electrode by a thermally conductive adhesive.

15. The secondary battery of claim 1, wherein the heat distribution channel is provided with a mesh structure formed of a plurality of wires.

16. The secondary battery of claim 1, wherein:
the electrode assembly is provided to be wound in a cylindrical shape; and
the heat distribution channel is formed to extend in a radial direction on one surface in a direction of a central shaft of the cylindrical shape to provide a heat transfer path between the inner region and the outer region in the radial direction.

17. The secondary battery of claim 16, wherein the heat distribution channel is provided as a plurality of heat distribution channels disposed on the one surface and spaced apart from each other in a circumferential direction.

18. The secondary battery of claim 16, wherein the heat distribution channel includes:
a first heat distribution channel disposed on a first surface in the direction of the central shaft and configured to connect a first electrode disposed in the inner region to a first electrode disposed in the outer region; and
a second heat distribution channel disposed on a second surface that is opposite to the first side and configured to connect the second electrode disposed in the inner region to the second electrode disposed in the outer region.
